(19) United States
(12) Patent Application Publication
(10) Pub. No.: US 2015/0044553 A1
(43) Pub. Date: Feb. 12, 2015

(54) CATHODE ACTIVE MATERIAL FOR NON-AQUEOUS RECHARGEABLE MAGNESIUM BATTERY

(71) Applicant: Toyota Motor Engineering & Manufacturing North America, Inc., Erlanger, KY (US)

(72) Inventor: Jiajun Chen, Ann Arbor, MI (US)

(73) Assignee: Toyota Motor Engineering & Manufacturing North America, Inc., Erlanger, KY (US)

(21) Appl. No.: 13/961,639

(22) Filed: Aug. 7, 2013

(51) Int. Cl. H01M 4/58; H01M 10/054

(52) U.S. Cl. CPC H01M 4/5825; H01M 10/054; H01M 2004/028
USPC 429/200; 429/213; 429/188; 429/221; 429/220

(57) ABSTRACT

A cathode for a magnesium battery that includes a current collector and an active material disposed on the current collector. The active material includes a metal organic framework with a cubic structure having iron or a transition metal on corners of the cubic structure. The corners are linked by a cyano group. The active material may have the formula: (MgA)ₓMFe(CN)₆ wherein A=K, Na, M=Fe, Cu, Ni, Co, Mn, Zn and 0≦×≦0.67.

### FIELD OF THE INVENTION

The invention relates to cathode active materials for rechargeable batteries.

### BACKGROUND OF THE INVENTION

Rechargeable batteries such as lithium ion and magnesium ion batteries have numerous commercial applications. Energy density is an important characteristic, and higher energy densities are desirable for a variety of applications.

A magnesium ion in a magnesium or magnesium ion battery carries two electrical charges, in contrast to the single charge of a lithium ion. Improved electrode materials would be useful in order to develop high energy density magnesium batteries.

### SUMMARY OF THE INVENTION

In one aspect, there is disclosed a cathode for a magnesium battery that includes a current collector and an active material disposed on the current collector. The active material having a metal organic framework with a cubic structure having iron or a transition metal on corners of the cubic structure, the corners linked by a cyano group.

In another aspect, there is disclosed a cathode for a magnesium battery that includes a current collector and an active material disposed on the current collector. The active material having the formula:

(MgA)ₓMFe(CN)₆ wherein A=K, Na, M=Fe, Cu, Ni, Co, Mn, Zn and 0≦×≦0.67.

In a further aspect, there is disclosed a magnesium ion battery that includes an anode and a non-aqueous electrolyte containing magnesium ions. A cathode having an active material having a metal organic framework with a cubic structure having iron or a transition metal on corners of the cubic structure, the corners linked by a cyano group is separated from the anode by the electrolyte.

In yet a further aspect, there is disclosed a magnesium ion battery that includes an anode and a non-aqueous electrolyte containing magnesium ions. A cathode having the formula: (MgA)ₓMFe(CN)₆ wherein A=K, Na, M=Fe, Cu, Ni, Co, Mn, Zn and 0≦×≦0.67 is separated from the anode by the electrolyte.

### BRIEF DESCRIPTION OF THE DRAWINGS

FIG. 1 is a perspective view of the structure of an active material compound having a cubic structure;

FIG. 2 is a plot of the x-ray diffraction of KFe(II)Fe(III)(CN)₆;

FIG. 3 is a diagram of initial Charge/discharge profiles with Mg anode/cathode KFe(II)Fe(III)(CN)₆ in 0.2 M PhMgCl—AlCl3/THF;

FIG. 4 are cycle profiles of Mg anode/cathode KFe(II)Fe(III)(CN)₆ in 0.2 M PhMgCl—AlCl3/THF in the voltage window of 0.8-3V vs Mg2+/Mg;

FIG. 5 is a plot detailing a comparison of the KFe(II)Fe(III)(CN)₆ discharge curve at different current density;

FIG. 6 is an SEM of KFe(II)Fe(III)(CN)₆;

FIG. 7 are cycle profiles of Mg anode/cathode KFe(II)Fe(III)(CN)₆ in LiBH4/Mg(BH4)2;

FIG. 8 are cycle profiles of Mg anode/cathode Copper hexacyanoferrate in 0.2 M PhMgCl—AlCl3/THF in the voltage window of 0.8-3V vs Mg2+/Mg;

FIG. 9 is an SEM of Copper hexacyanoferrate;

FIG. 10 is a plot of the potential versus current for KFe(II)Fe(III)(CN)₆ in 1 MMg(ClO4)2/Acetonitrile.

### DETAILED DESCRIPTION OF THE PREFERRED EMBODIMENTS

In one aspect, there is disclosed a cathode for a magnesium battery that includes a current collector and an active material disposed on the current collector. The active material having a metal organic framework with a cubic structure having iron or a transition metal on corners of the cubic structure. The corners are linked by a cyano group.

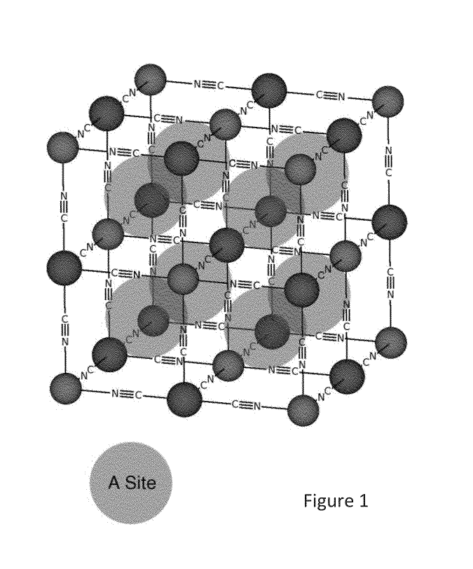

Referring to FIG. 1, there is shown the structure of the active material. In one aspect, the transition metal may be selected from copper and nickel. As can be seen in the figure, the active material has a highly open framework structure. The tetrahedrally coordinated A sites in the large cages in this porous framework may allow magnesium cation insertion reversibly without breaking down the structure.

In another aspect, there is disclosed a cathode for a magnesium battery that includes a current collector and an active material disposed on the current collector. The active material having the formula: (MgA)ₓMFe(CN)₆ wherein A=K, Na, M=Fe, Cu, Ni, Co, Mn, Zn and 0≦×0.67.

As can be seen from the formula above the active material may include additional metal ions including sodium and potassium in the cubic structure. Further, as stated above, the structure may include iron and other transition metals such as copper and nickel. In one aspect, the cathode active material may have the formula: MgKMFe(CN)6 wherein M=Mn, Fe, Co, Ni and Zn.

The cathode including the active material may be utilized with various electrolytes and a magnesium anode to form a magnesium ion battery. Electrolytes that may be utilized include Gringard electrolytes, LiBH₄/Mg(BH₄)₂ and conventional electrolytes. Gringard electrolytes may include PhMgCl—AlCl₃/THF. Conventional electrolytes may include MgTFSI (trifluoromethanesulfonimide) and Mg(CLO4)2/Acetonitrile. Additionally electrolytes based on borohydride materials may also be utilized.

### EXAMPLES

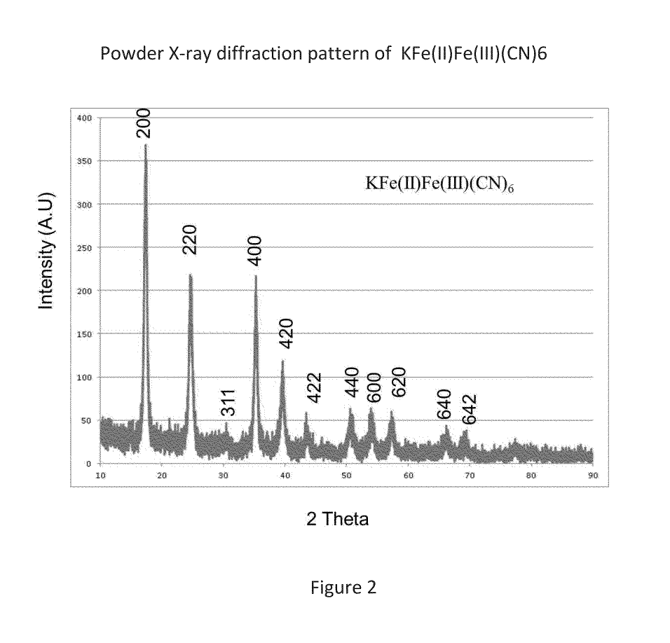

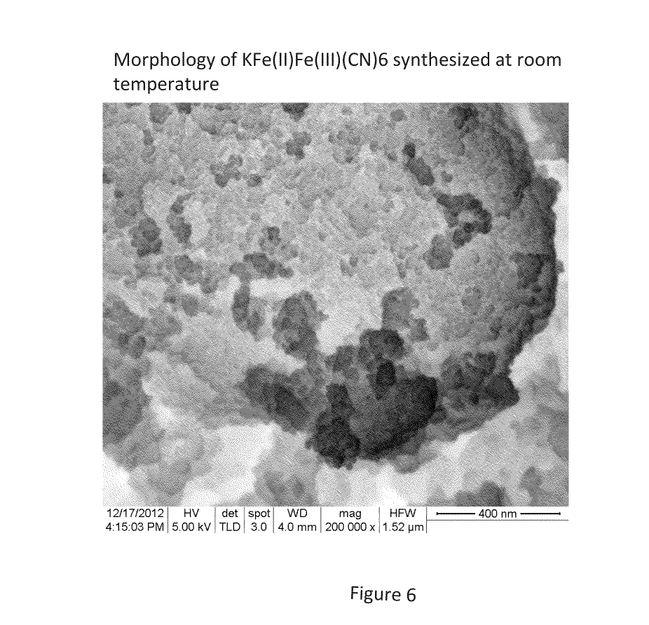

Cathode active material nanoparticles were synthesized at room temperature by slow addition of the M(II) salt solution into the K3Fe(CN)6 solution of with a strong magnetic stirring. The final products were dried in a vacuum oven at 100 C overnight. The primary particle size of the active material was about 20-30 nm and readily agglomerate into micron size as shown in FIG. 6 for the material KFe(II)Fe(III)(CN)₆. Powder x-ray diffraction, as shown in FIG. 2, of the formed material confirms the formation of KFe(II)Fe(III)(CN)₆.

The cathodes were prepared by mixing 70 wt. % active material, 20 wt. % carbon black and 10 wt. % poly(tefrafluoroethylene), pressed into a 120 μm thick pellet. The Tom cells with glassy carbon dish as a cathode current collector were assembled in an Ar-filled glove box and electrochemical properties were measured using a Biologic VMP multichannel potentiostat. The cycling was performed between 0.8 and 2.85 V (or 3V) vs Mg2+/Mg at constant current of 25 μA or 50 μA.

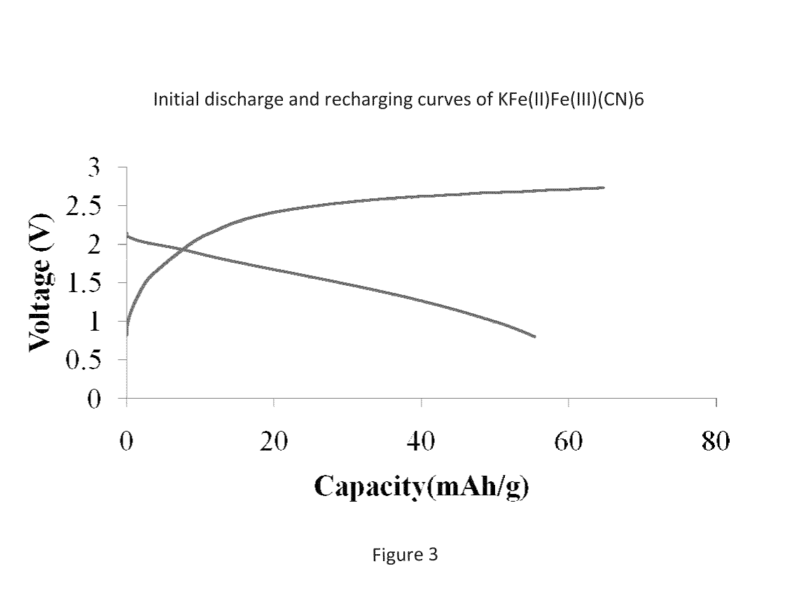

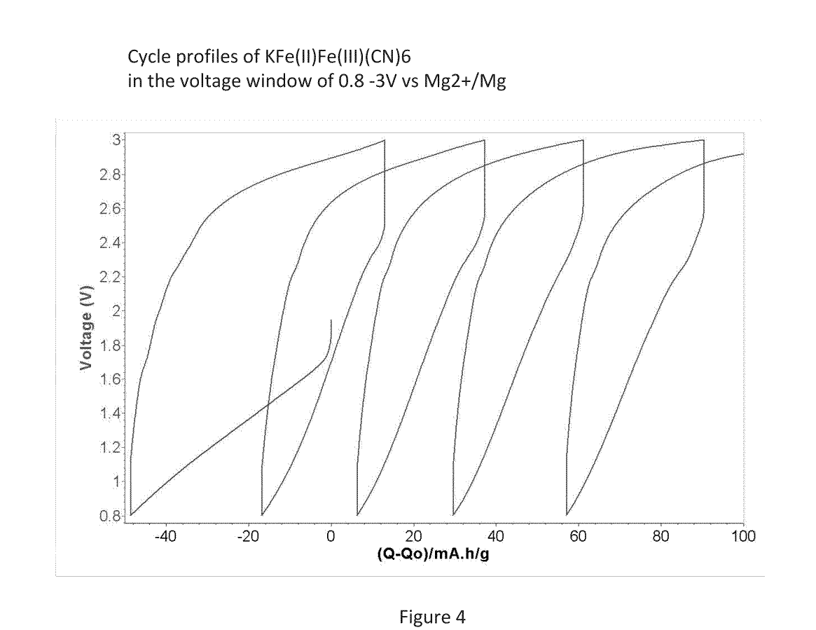

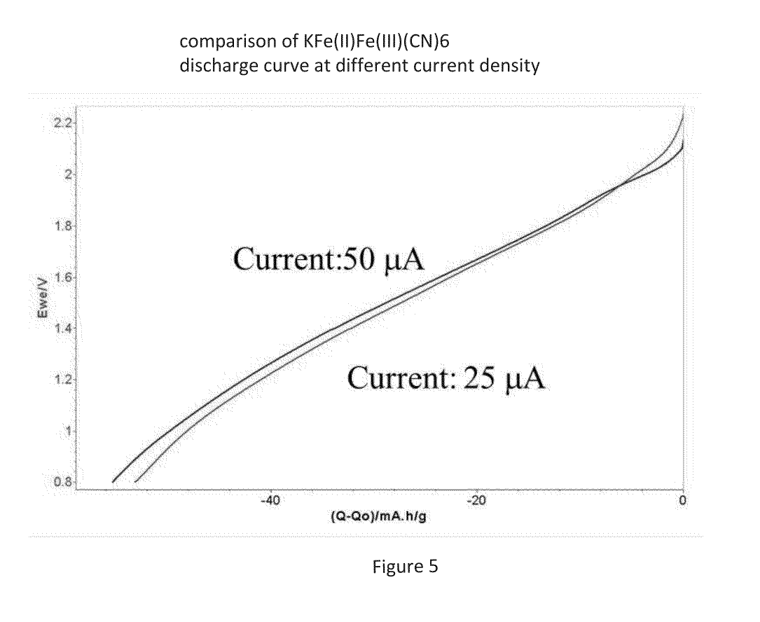

Various electrolytes were utilized in the electrochemical testing. In one aspect, a Grignard electrolyte of 0.2 M PhMgCl—AlCl3/THF solution was used with Mg foil as counter and reference electrodes. The initial charge and discharge profiles of the material are shown in FIG. 3 with additional cycling profiles shown in FIG. 4. As can be seen from the figures, reversible insertion and extraction of Magnesium ions from the cathode material occurred. The discharge profile of the active material remained stable at various currents of both 25 and 50 μA, as detailed in FIG. 5. The active material exhibited highly reversible capacity of about 50 mAh/g for multiple cycles. The open circuit voltage is around 2.4 V and cells provide discharge voltage from 2.5V to 0.8V which is higher than current prior art technologies.

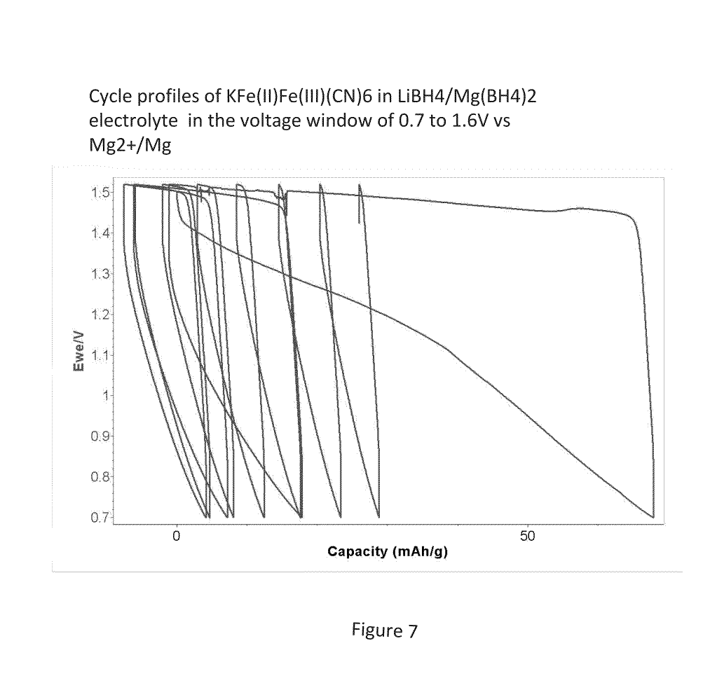

The active material KFe(II)Fe(III)(CN)₆ was also electrochemically tested with an electrolyte of LiBH₄/Mg(BH₄)₂. The borohydride electrolyte solution was used with Mg foil as counter and reference electrodes. The cycling profiles are shown in FIG. 7. As can be seen from the figure, reversible insertion and extraction of Magnesium ions from the cathode material occurred.

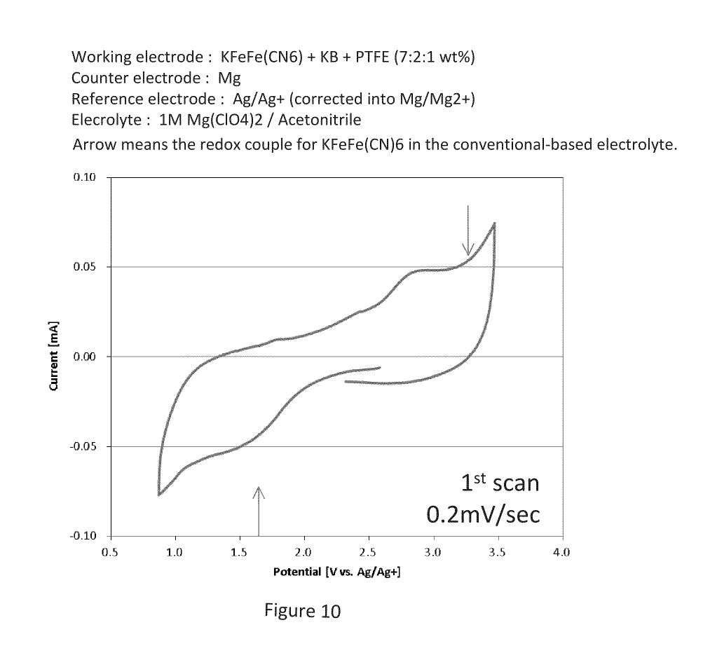

The active material KFe(II)Fe(III)(CN)₆ was also electrochemically tested with a conventional electrolyte of 1 MMg(ClO₄)₂. The conventional electrolyte solution was used with Mg foil as counter and reference electrodes. A plot of the current as a function of the potential is shown in FIG. 10. As can be seen from the figure, reversible insertion and extraction of Magnesium ions from the cathode material occurred.

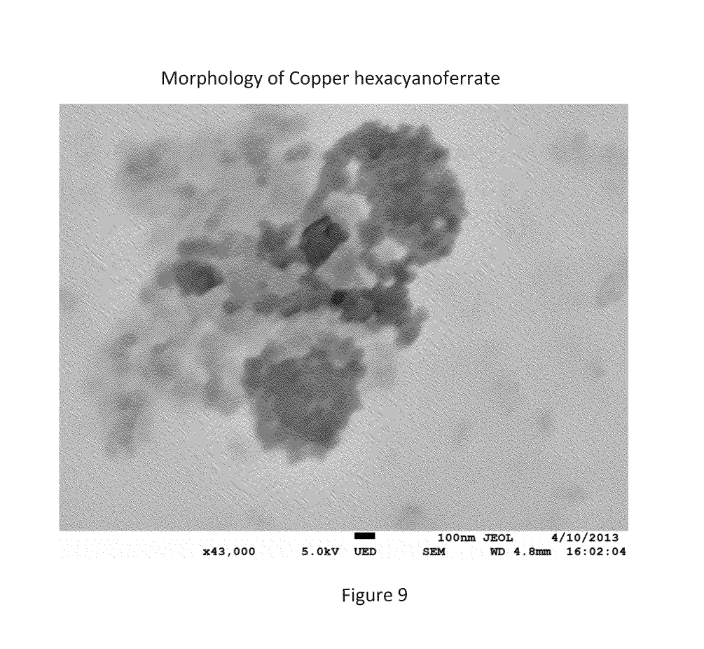

Cathode active material nanoparticles were synthesized at room temperature by slow addition of the M(II) salt solution into the K3Fe(CN)6 solution of with a strong magnetic stirring. The final products were dried in a vacuum oven at 100 C overnight. The primary particle size of the active material was about 20-30 nm and readily agglomerate into micron size as shown in FIG. 9 for the material Copper hexacyanoferrate.

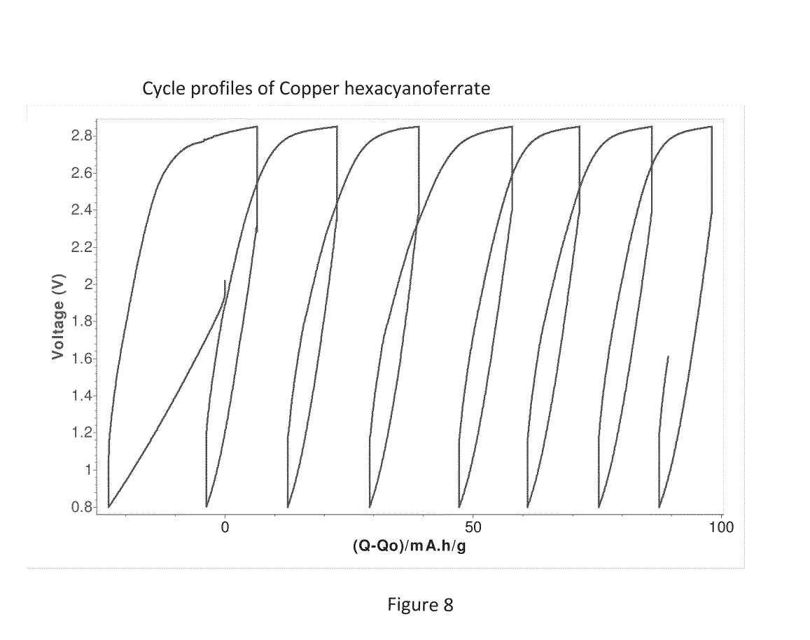

The cathodes were prepared by mixing 70 wt. % active material, 20 wt. % carbon black and 10 wt. % poly(tefrafluoroethylene), pressed into a 120 μm thick pellet. The Tom cells with glassy carbon dish as a cathode current collector were assembled in an Ar-filled glove box and electrochemical properties were measured using a Biologic VMP multichannel potentiostat. The cycling was performed between 0.8 and 2.85 V (or 3V) vs Mg2+/Mg at constant current of 25 μA. The cycling profiles are shown in FIG. 8. As can be seen from the figure, reversible insertion and extraction of Magnesium ions from the cathode material occurred.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A magnesium ion battery comprising:
an anode;
a non-aqueous electrolyte containing magnesium ions and
a cathode having an active material having a metal organic framework with a cubic structure having iron or a transition metal on corners of the cubic structure, the corners linked by a cyano group.

2. The magnesium ion battery of claim 1 further including metal ions within the cubic structure.

3. The magnesium ion battery of claim 2 wherein the metal ions are selected from Sodium and Potassium ions.

4. The magnesium ion battery of claim 1 wherein the transition metal is selected from copper and nickel.

5. The magnesium ion battery of claim 1 wherein magnesium ions intercalate into an out of the cathode active material during charging and discharging of the magnesium ion battery.

6. The magnesium ion battery of claim 1 wherein the non-aqueous electrolyte is selected from Gringard electrolytes, LiBH₄/Mg(BH₄)₂ and conventional electrolytes.

7. The magnesium ion battery of claim 1 wherein the Gringard electrolyte includes PhMgCl—AlCl₃/THF.

8. The magnesium ion battery of claim 1 wherein the conventional electrolyte includes MgTFSI (trifluoromethanesulfonimide) and Mg(ClO4)2/Acetonitrile.

9. A magnesium ion battery comprising:
an anode;
a non-aqueous electrolyte containing magnesium ions and
a cathode having an active material having the formula:
(MgA)ₓMFe(CN)₆ wherein A=K, Na, M=Fe, Cu, Ni, Co, Mn, Zn and 0≦×≦0.67.

10. The magnesium ion battery of claim 9 wherein magnesium ions intercalate into an out of the cathode active material during charging and discharging of the magnesium ion battery.

11. The magnesium ion battery of claim 9 wherein the non-aqueous electrolyte is selected from Gringard electrolytes, LiBH₄/Mg(BH₄)₂ and conventional electrolytes.

12. The magnesium ion battery of claim 9 wherein the Gringard electrolyte includes PhMgCl—AlCl₃/THF.

13. The magnesium ion battery of claim 9 wherein the conventional electrolyte includes MgTFSI (trifluoromethanesulfonimide) and Mg(ClO4)2/Acetonitrile.

14. The magnesium ion battery of claim 9 wherein the active material has the formula:
MgKMFe(CN)6 wherein M=Mn, Fe, Co, Ni and Zn.

15. A cathode for a non-aqueous magnesium battery comprising:
a current collector;
an active material disposed on the current collector, the active material having a metal organic framework with a cubic structure having iron or a transition metal on corners of the cubic structure, the corners linked by a cyano group.

16. A cathode for a non-aqueous magnesium battery comprising:
a current collector;
an active material disposed on the current collector, the active material having the formula:
(MgA)ₓMFe(CN)₆ wherein A=K, Na, M=Fe, Cu, Ni, Co, Mn, Zn and 0≦×≦0.67.
